(19) United States
(12) Patent Application Publication
(10) Pub. No.: US 2026/0133304 A1
(43) Pub. Date: May 14, 2026

(54) SYSTEMS AND METHODS FOR DETERMINISTIC NAVAID RADAR

(71) Applicant: AURA Network Systems, Inc., McLean, VA (US)

(72) Inventors: Tamara Lynne CASEY, Annapolis, MD (US); Gabriel TORRES, Seattle, WA (US)

(21) Appl. No.: 19/388,766

(22) Filed: Nov. 13, 2025

Related U.S. Application Data
(60) Provisional application No. 63/720,071, filed on Nov. 13, 2024.
(60) Provisional application No. 63/803,338, filed on May 9, 2025.

(51) Int. Cl. G01S 13/00; G01S 7/41; G01S 13/66; G01S 13/91

(52) U.S. Cl. CPC G01S 13/006; G01S 7/412; G01S 7/417; G01S 13/66; G01S 13/91

(57) ABSTRACT

Some examples of the disclosure are directed to implementing a passive and adaptive bistatic or multi-static radar system. Some examples of the disclosure are directed to using reflections from one or more navigational aids. Some examples of the disclosure are directed to generating a digital model of a physical environment to implement a deterministic passive radio system. Some examples of the disclosure are directed to collaborative approaches to identifying, locating, and track airborne objects.

### CROSS REFERENCE TO RELATED APPLICATIONS

This application claims the benefit of U.S. Provisional Application No. 63/803,338, filed May 9, 2025, and U.S. Provisional Application No. 63/720,071, filed Nov. 13, 2024, the contents of which are herein incorporated by reference in their entireties for all purposes.

### FIELD

The present disclosure relates generally to systems and methods for detecting the presence of and the track of airborne objects such as unmanned airborne vehicles (UAVs) and other cooperative and non-cooperative airborne objects in a variety of types of airspace.

### BACKGROUND

Conventional radar systems that are used to detect manned position and altitude information for aircraft often are complex and expensive to construct and operate. Often times, radar systems that are used to detect manned aircraft are designed to work in conjunction with a transponder that is installed in the aircraft. When interrogated by the radar, the transponder can transmit a coded signal back to the radar, providing its position as well as other pertinent information about the aircraft's identity. Often times, employing conventional radar systems to detect and track small UAVs leads to unacceptable results in which the UAV may not be detected with sufficient accuracy, or the path of travel (i.e., track) of the UAV is inaccurately portrayed. Moreover, designing radar systems by constructing new transmitters can be costly, spectrally inefficient, and can require active management and/or coordination between transmitters and receivers. This coordination may not be possible when an aircraft is not a “cooperative” aircraft (e.g., the aircraft is not operating as part of the radar network that is being used to track the aircraft). Thus, it can be appreciated that a radar system comprising receivers that leverage preexisting transmitter networks can reduce the cost and/or complexity of implementing a radar system for detecting UAVs.

By using preexisting transmitting systems such as those implemented for navigational aids, processing resources required to operate radar systems can be focused on management of a passive radar system rather than coordination between transmitters. Thus, a biststatic and/or multi-static radar system can simplify computational load and cost required to detect airborne objects. Typically, bistatic and/or multi-static radar systems rely upon a set of known transmitters to ensure that signals received by bistatic and/or multi-static receivers can be cross-referenced against characteristics of signals transmitted in order to discern a location and/or movement of an airborne object. It can be appreciated, however, that current solutions fail to integrate preexisting transmitters such as navigational aids in large part due to the dynamic nature of the transmitters servicing various aircraft that rely upon the navigational aids for guidance. In some examples, the use of navigational aids can introduce difficulties when attempting to predict or model how prospective transmissions may reflect off airborne objects and ultimately be received at bistatic or multi-static receivers. For example, NAVAIDs can change the channel, modulation scheme, transmission power, and/or some combination thereof dynamically while providing navigation aid to various aircraft. Thus, to minimize cost and complexity of a bistatic and/or multi-static radar system, it can be useful to identify and use information to model, and thereby predict, reflections of signals originally transmitted by the preexisting navigation transmitters.

### SUMMARY

Disclosed herein are systems and methods for a multi-static radar system that is configured to detect both crewed and uncrewed aircraft in a given airspace without the need for a transponder on the aircraft. In one or more examples, the multi-static radar system can leverage preexisting transmitting networks configured to act as navigation aids such as a Distance Measuring Equipment (DME) network to perform position, navigation, and timing operations relating to determining the position of an aircraft in flight. In one or more examples, the system disclosed herein obtains information to preemptively understand transmitting characteristics of the DME network, and models a physical environment of not only the DME network but also a bi-static/multi-static radar network. In one or more examples, one or more receivers can be used to deterministically identify a location and/or movement of aircraft.

In one or more examples, a bi-static/multi-static radar system can detect aircraft traveling through an airspace. In some examples, the DME-based multi-static radar system includes one or more receivers that are passive and/or adaptive. For example, the receivers can be configured to identify and/or tune to channels in use by navigational aid systems (e.g., DME systems). For purposes of illustration the disclosure refers to navigation aid systems as DME systems, but the use of the term should not be viewed as limiting—the concepts discussed herein can be applied to any navigational aid system. In one or more examples, the bi-static/multi-static radar system can be configured to tune to a DME system. Navigational aid systems, as described further herein, can refer to networks of transmitters and/or receivers used to facilitate and supplement navigation of aircraft transiting a geographic region.

In one or more examples, the bi-static/multi-static radar system can be an adaptive passive radar system. Passive radar systems can include systems that do not typically rely upon a transmitter that is co-located with a receiver, and also do not directly control transmissions that are emitted from the transmitters. In some examples, passive radar systems can rely upon transmitters that are distributed throughout an environment. In some examples, the passive radar system detects electromagnetic waves that have reflected off airborne objects (e.g., the passive radar system detects electromagnetic waves that have been transmitted by a transmitter, impinged upon an aircraft, and have been reflected by the aircraft back to the receiver). In some examples, the passive radar system can include receivers that opportunistically determine a location and/or track of the airborne objects. In some examples, the location is determined based on reflection from the transmitters that collide with and reflect from the airborne objects. In response to receiving the reflection signals, the passive radar system can process the reflected signals to ascertain spatial information including a location, speed, track, altitude, and/or some combination thereof of the airborne object.

In one or more examples, a bi-static/multi-static radar system can be passive system and can utilize signals transmitted by a navigational aid (NAVAID) transmitter to perform object detection and tracking. In one or more examples, a NAVAID system can operate in accordance with a set of known specifications. The specifications can define the operating characteristics of the transmitter, such as a power level, modulation scheme, periodicity, channelization of available spectrum, and the like. In one or more examples, the multi-static radar system can source information about the operating characteristics of NAVAID transmitters. One example of a NAVAID, among other described herein, is a distance measuring equipment (DME) system. A DME system can rely upon a time-of-arrival measurement to ascertain a distance and/or location of aircraft. Current DME specifications designate that transmitting occurs in different operating modes. In some examples, the operating modes include an interrogation mode, during which a DME transmitter transmits an identifier (e.g., in Morse code) indicating a location and/or other identifying information that corresponds to the DME transmitter on a first frequency channel. In some examples, the operating modes include a reply mode, during which the DME transmitter transmits signals toward an aircraft on a second frequency channel. This channel pair scheme can improve the likelihood that a given DME transmitter does not suffer from unwanted interference and/or prospective confusion between different aircraft transiting through a physical environment of the DME transmitter.

It can be appreciated that DME transmitters often transmit signals that can be utilized by passive bi-static/multi-static radar to detect reflections from airborne objects moving through a physical environment of the transmitters and/or the bi-static/multi-static radar system. In one or more examples, receivers included in the bi-static/multi-static radar system can be configured to detect reflections of DME signals that are transmitted by a DME transmitter and then reflected off of a surface of an aircraft that is transiting a coverage area of the DME network. In one or more examples, the reflections can correspond to airborne objects that are communicating with DME radar nodes. In one or more examples, the reflections can correspond to airborne objects that are not communicating with the DME radar nodes. Therefore, irrespective of whether an aircraft includes a transponder and/or explicitly is configured to communicate and/or rely upon DME base stations, a passive multi-static radar system can locate and/or track the aircraft by relying upon the reflected signals.

It can be appreciated that merely relying upon reflections from transmitted DME signals can leave some amount of uncertainty as to the specific location of aircraft. Therefore, it can be appreciated that utilizing a deterministic radar system to track an airborne object can decrease uncertainty and/or improve accuracy of location estimates of the aircraft. To that end, one or more controllers and/or processors can obtain information about the DME radar nodes that provide specific characteristics of the transmitters and additional or alternative information about the transmitters to provide information that can be used to improve the accuracy of the radar system.

In some examples, the information pertaining to the DME network can be incorporated into a digital model of the transmitters and/or transmitting environment that can be utilized to place receivers in the coverage area of the DME network and/or interpret reflection signals that are reflected by the airborne objects. In some examples, the digital model can be a digital twin of a physical environment that incorporates knowledge of geography, coverage volume, and/or power volumes of DME transmitters. Additionally or alternatively, the digital model can incorporate information indicating the power level, the frequency channels, the periodicity, the pattern, and/or some combination thereof of characteristics of a transmitter. In this way, one or more controllers can perform signal processing and digital modeling to enable deterministic radar detection of airborne objects, reducing the uncertainty and/or improving the accuracy of location and/or tracking estimates. It is understood that some examples of the disclosure described with reference to a radar system that incorporates reflections from DME transmitters can apply to additional or alternative radar systems that incorporate reflections from transmitters using a different NAVAID technology.

Using DME signals for UAV detection can decrease costs required to establish a radar system. By leveraging existing DME infrastructure, the system can operate without the need for extensive investment in construction of new transmitters. This improves allocation of capital and resources, focusing on detection and tracking capabilities without overhead associated with building and maintaining a separate transmitter network. Because the system can operate passively, implementing the system for purposes of radar detection can reduce the likelihood of detection by UAV operators.

In one or more examples, a device can generate a digital model of a plurality of radar systems in order to generate such recommendations and/or to evaluate the health and accuracy of the plurality of radar systems. In one or more examples, the device can further predict the position and/or track of objects detected by the plurality of radar systems. The device can further communicate feedback to the plurality of radar systems themselves in order to improve performance of the radar systems.

According to one or more examples of the disclosure, a system for detecting and tracking airborne objects, the system comprises a plurality of bi-static or multi-static receivers, wherein each bi-static or multi-static receiver is configured to receive a deterministic radio navigation signal associated with a radio navigational aid, memory, and one or more processors, wherein each processor of the one or more processors is communicatively coupled to each bistatic or multi-static receiver of the plurality of bistatic or multi-static receivers. In one or more examples, the memory stores one or more programs that when executed by the one or more processors, cause the one or more processors to: receive, from one or more of the plurality of bistatic or multi-static receivers, one or more reflections signals, wherein the one or more reflection signals correspond to one or more deterministic radio navigation signals transmitted by a radio navigational system, and determine a position of the one or more airborne objects based upon the received one or more reflection signals.

Optionally, the radio navigational system includes a Distance Measuring Equipment (DME) system.

Optionally, a first bistatic or multi-static receiver of the plurality of bistatic or multi-static receivers is configured to receive first reflection signals corresponding to a first channel wherein the first channel is utilized by the radio navigational aid system.

Optionally, wherein the one or more processors are further configured to: while a transmitting configuration associated with a first transmitter of one or more transmitters included in the radio navigational system corresponds to a first configuration, and while a first bistatic or multi-static receiver of the plurality of bistatic or multi-static receivers is configured with one or more first characteristics, receive first signals of the one or more reflected signals, determine that the transmitting configuration associated with the first transmitter changes from the first configuration to a second configuration, and in response to determining the change of the transmitting configuration, configure the first bistatic or multi-static receiver with one or more second characteristics, different from the one or more first characteristics, wherein the one or more second characteristics are associated with the second configuration of the first transmitter.

Optionally, the one or more first characteristics includes receiving the one or more reflection signals according to a first time signal pattern during which the receiver is inactive during first time periods, and the one or more second characteristics includes receiving the one or more reflection signals according to a second time signal pattern during which the receiver is inactive during second time periods.

Optionally, determining the position includes using a digital twin model of a physical environment of the radio navigational system.

Optionally, the one or more programs when executed by the one or more processors, further cause the one or more processors to: receive operational data from radio navigational system, and in response to receiving the operational data, update configurations of one or more of the one or more receivers.

Optionally, a geometry of the plurality of bistatic or multi-static receivers is arranged based upon a geometry of a physical environment in the radio navigational aid system is located.

Optionally, the one or more airborne objects that are located by the system are different from one or more aircraft that are configured to communicate an indication of the location of the one or more aircraft to the system.

According to one or more examples of the disclosure, a method for detecting and tracking one or more airborne objects, comprises: receiving, from one or more of a plurality of bistatic or multi-static receivers, one or more reflections signals, wherein the one or more reflection signals correspond to one or more deterministic radio navigation signals transmitted by a radio navigational system, and determining a position of the one or more airborne objects based upon the received one or more reflection signals.

According to one or more examples of the disclosure, a non-transitory computer readable storage medium storing one or more programs for detecting and tracking one or more airborne objects, for execution by one or more processors of an electronic device that when executed by the electronic device, cause the electronic device to: receive, from one or more of a plurality of bistatic or multi-static receivers, one or more reflections signals, wherein the one or more reflection signals correspond to one or more deterministic radio navigation signals transmitted by a radio navigational system, and determine a position of the one or more airborne objects based upon the received one or more reflection signals.

According to one or more examples of the disclosure a method comprises: receiving first information including one or more characteristics of one or more transmitters associated with a radio navigational aid system, selecting one or more bistatic or multi-static receivers from a plurality of bistatic or multi-static receivers in a bistatic or multi-static radar network to receive one or more reflection signals, wherein the one or more reflection signals correspond to one or more deterministic radio navigation signals transmitted by the radio navigational aid system that are generated by the one or more transmitters, and wherein the selection of the one or more bistatic or multi-static receivers from the plurality of bistatic or multi-static receivers is based on the first information, and obtaining second information by processing at least one of the one or more reflection signals received at the selected one or more bistatic or multi-static receivers.

Optionally, the selection of the one or more bistatic or multi-static receivers based on the first information includes: determining one or more coverage volumes of the one or more transmitters in accordance with the first information, and generating a model indicating signal propagation characteristics of an environment of the one or more transmitters based on the one or more coverage volumes.

Optionally, the selection of the bistatic or multi-static receiver based on the first information includes: when the signal propagation characteristics of a first region that includes first one or more bistatic or multi-static receivers satisfy one or more criteria, selecting the first one or more bistatic or multi-static receivers as the one or more selected receivers, and when the signal propagation characteristics of a second region that includes second one or more bistatic or multi-static receivers satisfy the one or more criteria, selecting the one or more second bistatic or multi-static receivers as the one or more selected receivers.

Optionally, the selection of the one or more bistatic or multi-static receivers based on the first information includes: when the first information indicates that a first transmitter is configured in an operational state, selecting first one or more bistatic or multi-static receivers as the selected one or more receivers, and when the first information indicates the first transmitter is configured in a non-operational state, forgoing selecting of the first one or more bistatic or multi-static receivers as the selected one or more receivers.

Optionally, navigational aid system includes a Distance Measuring Equipment (DME) system.

Optionally, the first information includes schedule information associated with the one or more transmitters of the radio navigational aid system.

Optionally, the first information includes information about a coverage volume of at least a first transmitter of the one or more transmitters relative to a three-dimensional environment.

Optionally, the first information includes historical information about signals transmitted by one or more transmitters included in the radio navigational aid system.

Optionally, first information includes historical information about airborne activity in a coverage area of the radio navigational aid system.

Optionally, the method further comprises determining which of one or more transmitters included in the radio navigational aid system are configured to transmit during a first period of time.

According to one or more examples of the disclosure, a system for detecting and tracking one or more airborne objects comprises: one or more bistatic or multi-static receivers, a memory, and one or more processors, wherein each processor of the one or more processors is communicatively coupled to each bistatic or multi-static receiver of the plurality of bistatic or multi-static receivers, wherein the memory stores one or more programs that when executed by the one or more processors, cause the one or more processors to perform any one the methods described herein.

According to one or more examples of the disclosure, a non-transitory computer readable storage medium can store one or more programs for detecting and tracking one or more airborne objects, for execution by one or more processors of an electronic device that when executed by the device, cause the device to perform any one the methods described herein.

One or more examples of the disclosure are directed to an electronic device comprising a memory. In one or more examples, the electronic device comprises one or more processors. In one or more examples, the memory stores one or more programs that when executed by the one or more processors, cause the one or more processors to receive first coverage and performance information corresponding to a plurality of radar systems. In one or more examples, the memory stores one or more programs that when executed by the one or more processors, cause the one or more processors to generate a virtual model of an airspace associated with first coverage and performance of the plurality of radar systems, In one or more examples, the memory stores one or more programs that when executed by the one or more processors, cause the one or more processors to validate the first coverage and performance information using the virtual model. In one or more examples, the memory stores one or more programs that when executed by the one or more processors, cause the one or more processors to transmit a result of the validation of the first coverage and performance information based on the virtual model.

Additionally or alternatively, in one or more examples, the result of the validation is communicated to a second electronic device that is different from the electronic device, wherein the second electronic device is configured to generate a radar track based on information received from the plurality of radar systems.

Additionally or alternatively, in one or more examples, the one or more processors are further caused to transmit, to the second electronic device, one or more recommended radar systems selected from the plurality of radar systems based on the result of the validation.

Additionally or alternatively, in one or more examples, the result of the validation includes, first validation results of a first radar system included in the plurality of radar systems, and second validation results of a second radar system, different from the first radar system, included in the plurality of radar systems. In one or more examples, the memory stores one or more programs that when executed by the one or more processors, cause the one or more processors to, in accordance with a determination the first validation results satisfy one or more criteria, transmit a first recommendation corresponding to the first radar system, and in accordance with a determination that the second validation results satisfy the one or more criteria and the first validation results do not satisfy the one or more criteria, transmit a second recommendation corresponding to the second radar system.

Additionally or alternatively, in one or more examples, the one or more processors are further caused to apply one or more machine learning models to the received first coverage and performance information to combine information received from the plurality of radar systems.

Additionally or alternatively, in one or more examples, the result of the validation indicate performance of one or more radar systems included in the plurality of radar systems.

Additionally or alternatively, in one or more examples, the first coverage and performance information include automatic dependent surveillance-broadcast (ADS-B) data received from one or more flights transiting a coverage area of the plurality of radar systems.

Additionally or alternatively, in one or more examples, the plurality of radar systems include a first radar system, wherein the first radar system has first characteristics, and a second radar system, different from the first radar system, wherein the second radar system has second characteristics, different from the first characteristics.

Additionally or alternatively, in one or more examples, the first radar system or the second radar system correspond to a 5G network, a passive radar network, or a deterministic radar network.

Additionally or alternatively, in one or more examples, the memory stores one or more programs that when executed by the one or more processors, cause the one or more processors to receive radar signature information from one or more of the radar systems of the plurality of radar systems, wherein the radar signature information includes a plurality of radar signatures corresponding to a plurality of aircraft.

Additionally or alternatively, in one or more examples, the memory stores one or more programs that when executed by the one or more processors, cause the one or more processors to identify an aircraft moving through an airspace of the one or more radar systems, wherein the identification of the aircraft is based on a comparison between a measured radar signature received from the one or more radar systems and the plurality of radar signatures previously received from the one or more radar systems.

Additionally or alternatively, in one or more examples, the identification of the aircraft is based on one or more machine learning models.

Additionally or alternatively, in one or more examples, the measured radar signature is based on one or more of an aircraft speed, size, altitude, and flight pattern.

Additionally or alternatively, in one or more examples, the memory stores one or more programs that when executed by the one or more processors, cause the one or more processors to receive an indication of changes to one or more radar systems included in the plurality of radar systems. In one or more examples, the memory stores one or more programs that when executed by the one or more processors, cause the one or more processors to, in response to receiving the indication of the changes, update the virtual model based on the changes to the one or more radar systems.

Additionally or alternatively, in one or more examples, the virtual model of the airspace is further based on a modelling of a plurality of radar system deployments.

One or more examples of the disclosure are directed system for detecting and tracking one or more airborne objects, the system comprising, one or more bistatic or multi-static radars, a memory, and one or more processors, wherein each processor of the one or more processors is communicatively coupled to each bistatic or multi-static radars of the plurality of bistatic or multi-static radars, wherein the memory stores one or more programs that when executed by the one or more processors, cause the one or more processors to perform any one of the methods described above.

One or more examples of the disclosure are directed a non-transitory computer readable storage medium storing one or more programs for detecting and tracking one or more airborne objects, for execution by one or more processors of an electronic device that when executed by the device, cause the electronic device to perform any one of the methods described above.

### BRIEF DESCRIPTION OF THE FIGURES

The invention will now be described, by way of example only, with reference to the accompanying drawings, in which:

FIG. 1 illustrates an exemplary multi-static radar network implemented with multi-static radar nodes according to examples of the disclosure.

FIGS. 2A-2C illustrates exemplary operation of a system leveraging navigational aids according to examples of the disclosure.

FIG. 3 illustrates a process for detecting airborne objects using adaptative multi-static radar according to examples of the disclosure.

FIG. 4 illustrates a multi-static radar network based on a virtual model according to examples of the disclosure.

FIG. 5 illustrates an exemplary process for operating a multi-static radar network to detect airborne objects according to examples of the disclosure.

FIG. 6 illustrates an exemplary system for characterizing and recommending radar systems using a virtual model according to examples of the disclosure.

FIG. 7 illustrates an exemplary system for identifying aircraft based on a collection of radar signatures according to examples of the disclosure.

FIG. 8 illustrates an exemplary computing system, according to examples of the disclosure.

FIG. 9 illustrates an exemplary process for characterizing and recommending radar systems using a virtual model according to examples of the disclosure.

### DETAILED DESCRIPTION

Reference will now be made in detail to implementations and examples of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Disclosed herein are systems and methods for a bi-static/multi-static radar system that is configured to detect both crewed and uncrewed aircraft in a given airspace without the need for a transponder on the aircraft. In one or more examples, the bi-static/multi-static radar system can leverage preexisting transmitting networks configured to act as navigation aids such as a Distance Measuring Equipment (DME) network to perform position and navigation operations relating to determining a three-dimensional position of an aircraft in flight. In one or more examples, the system disclosed herein obtains information to preemptively understand transmitting characteristics of the DME network, and models a physical environment of a multi-static radar network. In one or more examples, one or more receivers can be used to deterministically identify a location and/or movement of aircraft.

In one or more examples, a bi-static/multi-static radar system can detect aircraft traveling through an airspace. In some examples, the DME-based bi-static/multi-static radar system includes one or more receivers that are passive and/or adaptive. For example, the receivers can be configured to identify and/or tune to channels in use by navigational aid systems (e.g., DME system). For purposes of illustration the disclosure refers to navigation aid systems as DME systems, but the use of the term should not be viewed as limiting and the concepts discussed herein can be applied to any navigational aid system. In one or more examples, the bi-static/multi-static radar system can be configured to tune to a DME system transmit frequency. Navigational aid systems, as described further herein, can refer to networks of transmitters and/or receivers used to facilitate and supplement navigation of aircraft transiting a geographic region.

In one or more examples, the bi-static/multi-static radar system can be an adaptive passive radar system. Passive radar systems can include systems that do not typically rely upon a transmitter that is co-located with a receiver, and also do not directly control transmissions that are emitted from the transmitters. In some examples, passive radar systems can rely upon transmitters that are distributed throughout an environment. In some examples, the passive radar system detects electromagnetic waves that have reflected off airborne objects (e.g., the passive radar system detects electromagnetic waves that have been transmitted by a transmitter, impinged upon an aircraft, and have been reflected by the aircraft back to the receiver. In some examples, the passive radar system can include receivers that opportunistically determine a location and/or track of the airborne objects. In some examples, the location is determined based on reflection from the transmitters that collide with and reflect from the airborne objects. In response to receiving the reflection signals, the passive radar system can process the reflected signals to ascertain spatial information including a location, speed, track, altitude, and/or some combination thereof of the airborne object.

In one or more examples, a bi-static/multi-static radar system can be passive system and can utilize signals transmitted by a navigational aid (NAVAID) transmitter to perform object detection and tracking. In one or more examples, a NAVAID system can operate in accordance with a set of known specifications. The specifications can define the operating characteristics of the transmitter, such as a power level, modulation scheme, periodicity, channelization of available spectrum, and the like. In one or more examples, the bi-static/multi-static radar system can source information about the operating characteristics of NAVAID transmitters. One example of a NAVAID, among other described herein, is a distance measuring equipment (DME) system. A DME system can rely upon a time-of-flight measurement to ascertain a distance and/or location of aircraft. Current DME specifications designate that transmitting occurs in different operating modes. In some examples, the operating modes include an interrogation mode, during which a DME transmitter transmits an identifier (e.g., in Morse code) indicating a location and/or other identifying information that corresponds to the DME transmitter on a first frequency channel. In some examples, the operating modes include a reply mode, during which the DME transmitter transmits signals toward an aircraft on a second frequency channel. This channel pair scheme can improve the likelihood that a given DME transmitter does not suffer from unwanted interference and/or prospective confusion between different aircraft transiting through a physical environment of the DME transmitter.

It can be appreciated that DME transmitters often transmit signals that can be utilized by passive multi-static radar to detect reflections from airborne objects moving through a physical environment of the transmitters and/or the multi-static radar system. In one or more examples, receivers included in the multi-static radar system can be configured to detect reflections of DME signals that are transmitted by a DME transmitter and then reflected off of a surface of an aircraft that is transiting a coverage area of the DME network. In one or more examples, the reflections can correspond to airborne objects that are communicating with DME radar nodes. In one or more examples, the reflections can correspond to airborne objects that are not communicating with the DME radar nodes. Therefore, irrespective of whether an aircraft includes a transponder and/or explicitly is configured to communicate and/or rely upon DME base stations, a passive multi-static radar system can locate and/or track the aircraft by relying upon the reflected signals.

It can be appreciated that merely relying upon reflections from transmitted DME signals can leave some amount of uncertainty as to the specific location of aircraft. Therefore, it can be appreciated that utilizing a deterministic radar system to track an airborne object can decrease uncertainty and/or improve accuracy of location estimates of the aircraft. To that end, one or more controllers and/or processors can obtain information about the DME radar nodes that provide specific characteristics of the transmitters and additional or alternative information about the transmitters to provide information that can be used to improve the accuracy of the radar system.

In some examples, the information pertaining to the DME network can be incorporated into a digital model of the transmitters and/or transmitting environment that can be utilized to place receivers in the coverage area of the DME network and/or interpret reflection signals that are reflected by the airborne objects. In some examples, the digital model can be a digital twin of a physical environment that incorporates knowledge of geography, coverage volume, and/or power volumes of DME transmitters. Additionally or alternatively, the digital model can incorporate information indicating the power level, the frequency channels, the periodicity, the pattern, and/or some combination thereof of characteristics of a DME transmitter. In this way, one or more controllers can perform signal processing and digital modeling to enable deterministic radar detection of airborne objects, reducing the uncertainty and/or improving the accuracy of location and/or tracking estimates. It is understood that some examples of the disclosure described with reference to a radar system that incorporates reflections from DME transmitted signals can apply to additional or alternative radar systems that incorporate reflections from transmitted signals of different NAVAID technology.

Using DME signals for UAV detection can decrease costs required to establish a radar system. By leveraging existing DME infrastructure, the system can operate without the need for extensive investment in construction and maintenance of new transmitters. This improves allocation of capital and resources, focusing on detection and tracking capabilities without overhead associated with building and maintaining a separate transmitter network. Because the system can operate passively, implementing the system for purposes of radar detection can reduce the likelihood of detection by UAV operators.

In the following description of the various examples, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, solid state drives (SSDs), optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

Crewed (i.e., “manned” aircraft (i.e., commercial, cargo, private, and military aircraft)) have been tracked by radar systems for many decades. The radar systems employed to track manned aircraft have been optimized to the size and speed of conventional aircraft to ensure accurate and reliable identification of the aircraft, and to track aircraft transiting a given coverage area of the radar system. For instance, in one or more examples, a sensitivity of the radar has been optimized such that the system can detect the aircraft while minimizing false positives (i.e., determining that an aircraft is present, when no aircraft is actually present).

Unmanned aircraft (i.e., UAVs) present a challenge to traditional active radar systems. UAVs tend to be smaller in size and more maneuverable, meaning UAVs are not only difficult to detect using conventional radar, but are also more difficult to track (i.e., track the path of movement of the aircraft and its speed in the event that the aircraft is moving and not hovering). The sensitivity of conventional radar systems can be increased such that they can be utilized to detect smaller UAVs, however, doing so could also increase the rate of false positives, thereby lowering the accuracy of the entire system. Additionally, conventional radar networks often require that aircraft operating within the network be equipped with a transponder in order to correlate detection of an object using the radar to an aircraft flying in the coverage area of the radar.

In one or more examples, a multi-static radar network can be employed to detect and track UAVs. As described in further detail below, a multi-static radar network can include a plurality of “radar nodes” and/or a plurality of receivers (i.e., spatially diverse monostatic and/or bistatic radars) that can collectively determine the location, elevation, speed, and/or track of a UAV transiting the coverage area of the radar network. In one or more examples, the data collected from each of the receivers in the network can be “fused” together from multiple receivers and processed to determine, with improved accuracy, the location, elevation, speed, and/or track of a UAV. By dispersing the receivers throughout the coverage area of the system, it becomes more likely that a target aircraft will be physically closer to at least one receiver, and thus will have a sufficient signal reflection to make detection and tracking more feasible. As will be discussed in further detail below, using signals transmitted by the DME system to enable a deterministic radar system can reduce cost of implementing the system and/or reduce processing resources required to manage the radar system.

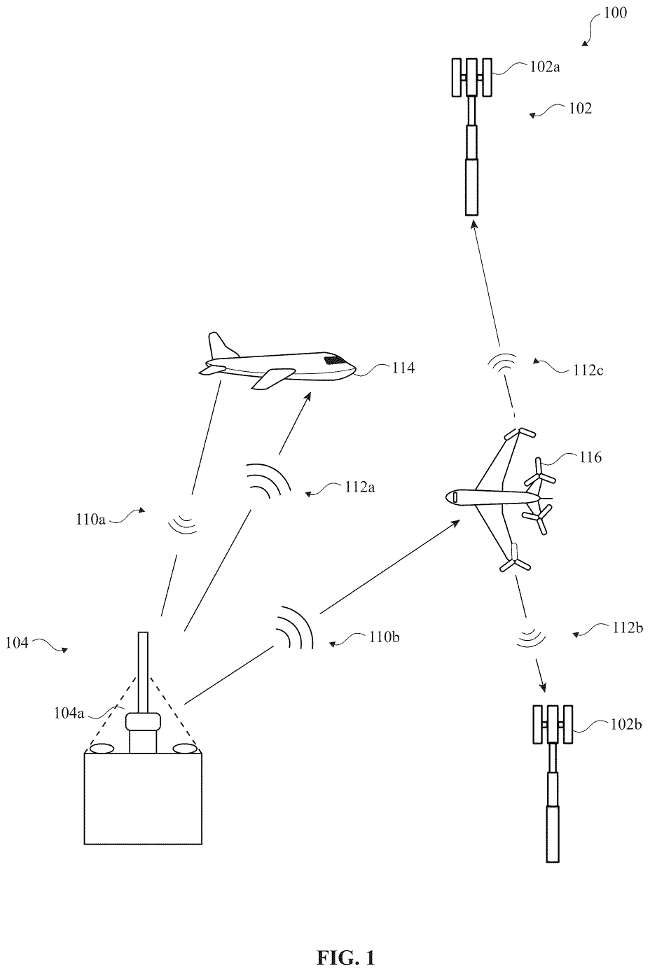

FIG. 1 illustrates an exemplary multi-static radar network implemented with multi-static radar nodes according to examples of the disclosure. In one or more examples, the system 100 of FIG. 1 illustrates an exemplary multi-static radar network that is configured to detect and track UAVs and other smaller airborne traffic. In one or more examples, the system 100 can include a plurality of radar nodes. A bistatic radar node can refer to a radar node in the network of radars in which the transmitter and receiver are geographically separated from one another. For example, a first radar node can include a transmitter 104a and a receiver 102a that are geographically separated from one another. In one or more examples of the disclosure, the geographic distance and relative position of the transmitter 104a and receiver 102a can be pre-configured based on the desired performance of the radar system. Additionally or alternatively, a second radar node can include transmitter 104a and receiver 102b. A transmitter can refer to the portion of the radar node that transmits an electromagnetic signal such as a pulse or other modulated waveform. A receiver can refer to the portion of the radar node that receives reflections from signals that are transmitted by the transmitter and reflect off airborne objects traversing the coverage area of the radar system. While the examples of system 100 disclose two different radar nodes, the number of nodes shown should be seen as exemplary and not limiting to the disclosure. The term “monostatic” can refer to a radar node in which the receiver and transmitter of the radar node are co-located. It is understood that the radar networks described herein can include one or more monostatic and/or bistatic radar nodes. For example, a central controller can communicate with a first set of bistatic and/or multi-static receivers and can additionally or alternatively communicate with a second set of bistatic and/or multi-static receivers.

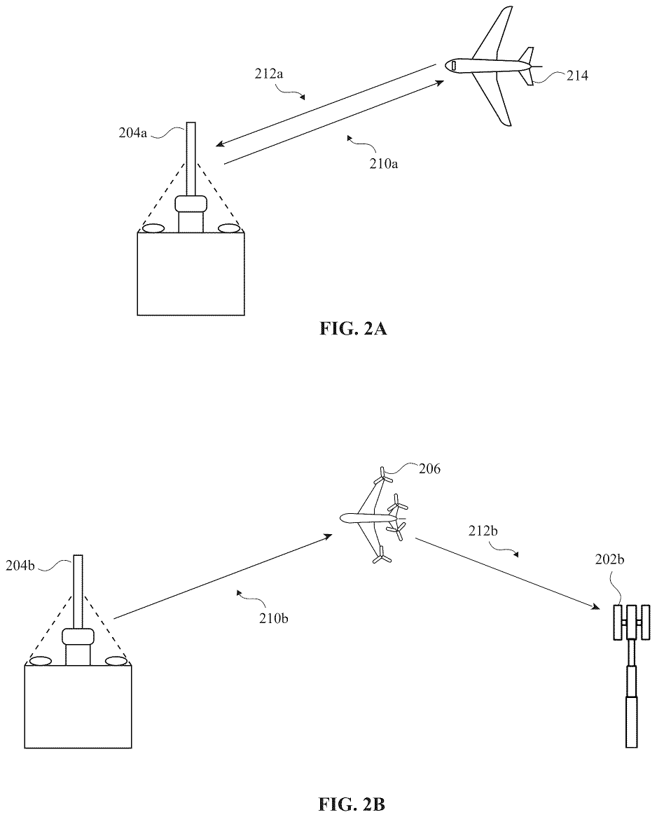

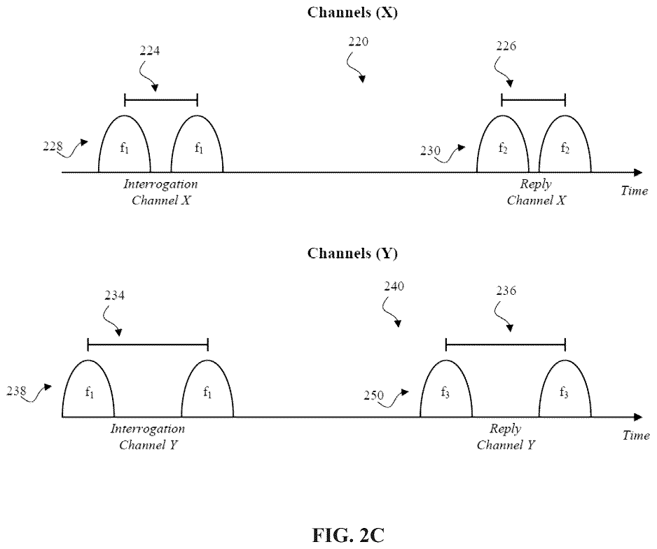

In one or more examples, transmitter 104a can transmit an electromagnetic signal in the airspace of the coverage area, such as signal 112a toward aircraft 114. In response to and/or after receiving signal 112a, aircraft 114 can transmit signal 110a toward radar node 104, which can include transmitter 104a. The electromagnetic signal (e.g., signal 112a) can then impinge upon an airborne object and then reflect back towards the radar node when scattered by the object, wherein the reflected signal can be detected/received by the receiver at the radar node. To facilitate description of the impinging and reflecting, signal 110b represents a signal transmitted from transmitter 104a that impinges upon airborne object 116. In one or more examples, transmitter 104a can be a DME transmitter, such as one or more of the transmitters described with reference to FIGS. 2A-2C. In one or more examples, and as further described below, the DME transmitters can be part of a navigational transmitter network that is configured to provide aircraft with navigational guidance during flight. The DME transmitters can be opportunistically utilized to perform position, navigation, and timing functions in support of determining the position of an airborne object. In one or more examples, the receiver of a given radar node can also receive signals reflected from signals transmitted by other transmitters of other radar nodes. For instance, using the system 100 as an example, a signal 110b transmitted from the transmitter 104a can be reflected off an airborne object and that reflection can be received by not only the receiver associated with the first radar node, but can also be received by other receivers in the system 100 such as receiver 102b.

In one or more examples, the transmitter for a radar node can be included in a radio navigational aid network. In this context, a radio navigational aid can correspond to radio systems designed to supplement and/or guide aircraft and/or other vehicles transiting through an airspace. While the examples disclosed herein describe the radar network in terms of receiving and interacting with DME signals, the disclosure should not be seen as limiting and is applicable to other navigation aid networks. For example, a navigational aid network can correspond to one or more of: a non-directional beacon (NBDs), instrument landing systems (ILS), distance measuring equipment (DME), very high frequency (VHF) omnidirectional range beacons (VORs), required navigation performance (RNP), and/or some combination thereof. Some examples of the disclosure are directed to DME systems. It is understood that description of such systems are merely examples, and that additional or alternative techniques using transmitters from other types of navigational aid networks can be contemplated without departing from the scope of the present disclosure. Some examples of the disclosure relate to the manner with which DME systems operate, but it is understood that additional or alternative NAVAID systems can be employed to implement a bistatic and/or multi-static radar system. For example, the bistatic and/or multi-static radar system can use VOR transmissions to implement an ad hoc primary radar system.

In one or more examples, informational sources such as the Federal Aviation Administration (FAA) can publish information about such transmitters and/or can require the transmitters operate in accordance with a set of publicly available specifications. In one or more examples, a bistatic and/or multi-static radar system can obtain information about the DME network, and can configure or tune receivers in the radar system to detect signals generated by the transmitters. Armed with knowledge of transmitter characteristics including frequency, signal strength, modulation type, transmitting periodicity, transmitting patterns, and/or the like, system 100 can treat the transmitter as a deterministic component of a radar system. In one or more examples, because the transmitter is deterministic, system 100 can detect reflections of the transmitted waves that reflect off airborne objects which when received, can precisely indicate the location of the airborne objects. Thus, system 100 can determine the location, altitude, speed, and/or track of a target moving through an airspace by receiving deterministic radio DME signals transmitted by a DME network.

In one or more examples, each of the radar nodes (e.g., the receivers that are configured to receive reflection signals) can be communicatively coupled to a central processor. In one or more examples, the processor can be configured to receive position data for each radar node transmitter and reflection signals from each of the radar nodes and can process the received signals to determine the location, elevation, speed, and/or track of an airborne object transiting the airspace covered by the coverage area of the network. In one or more examples, the processor can receive reflection signals from each of the radar nodes and “fuse” the received data together with transmitter position data to determine the location, elevation, speed, and/or track of objects transiting the airspace of the coverage area of the network. In one or examples, “fusing” the data together can include determining an angle of transmit and an angle of refection for each received reflection signal. By calculating angle of transmit, angle of reflection data, and/or time-of-flight (TOF) of signals for each radar node in which a signal is transmitted and received from, the location of the airborne object can be triangulated to determine the precise location, elevation, speed, and/or track of the aircraft. In one or more examples, the angle of transmit can refer to the angle between the transmitter and the object receiving the transmitted signal. In one or more examples, the angle of reflection can refer to the angle between the object and the receiver that received the reflection signal.

In one or more examples, the location of each of receivers 102a-b, and specifically the distances between the individual nodes, can be based on the desired performance of the radar network and based on the desired coverage area of the radar network. In one or more examples, the location of receivers 102a-b can be chosen to provide radar coverage that is not serviced by currently implemented radar networks. For example, receivers 102a-b and additional or alternative receivers can be placed at locations not covered by federal radar systems, and/or at locations where current radar networks provide inconsistent coverage. Additionally or alternatively, the locations of receivers 102a-b can be selected to provide granular coverage of key regions of an airspace. In some examples, receivers 102a-b are placed around one or more DME transmitters.

In one or more examples, receivers are placed in locations that correspond to the locations of DME transmitters. For example, receivers 102a-b can be placed at locations within a physical environment surrounding the transmitter 104a. The specific locations of receiver 102a and/or 102b can be selected in view of terrain, transmitting characteristics of transmitter 104a, and/or potential spacing and/or directions between receiver 102a and 102b. In one or more examples the placement of receivers 102a-b can improve the likelihood that a radar system including receivers 102a-b detects aircraft transiting the airspace in proximity to receivers 102a-b. Additionally or alternatively, the placement of receivers 102a-b can be selected to improve and/or maximize the likelihood that DME signals reflecting off of the aircraft are detected by receivers 102a-b, and/or that the reflected signals are detected with a level of power and/or strength greater than a threshold level of power and/or strength, a signal to noise ratio (SNR) that is greater than a threshold SNR level, a level of signal quality that is greater than a threshold quality level, and/or with a phase shift less than a threshold phase shift.

In one or more examples, the configuration of the network (i.e., the placement of the receivers in the network) can be based on known (pre-planned) flight routes to improve flight-based object awareness. Additionally, or alternatively, the placement of the radar receivers in the network can be based on known infrastructure site locations such as airports, heliports, vertiports, known flight routes (i.e., SIDs, STARs, Victory Airways, VFR Flight corridors), and other known types of infrastructure. In other words, by placing the radar receivers such that the coverage area covers known flight routes, the likelihood of detecting aircraft (rather than false positives such as birds) can be maximized. Additionally or alternatively, as described with respect to the digital model of the environment herein, the placement of radar receivers can correspond to regions of a physical environment that are not currently monitored by publicly accessible or publicly owned radar systems.

FIGS. 2A-2C illustrates exemplary operation of a system leveraging DME navigational aids according to examples of the disclosure. FIG. 2A, for example, illustrates an aircraft 214 communicating with a radar node 204a. Specifically, radar node 204a can transmit signal 210a, which can radiate with an omnidirectional radiation pattern, and can receive signal 212a from aircraft 214. As described further herein, radar node 204a can include a DME transmitter.

In some examples, a DME NAVAID system can communicate with an aircraft moving through airspace, as described above. Radar node 204a, for example, can include a NAVAID transmitter such as a DME transmitter. In some examples, radar node 204a transmits one or more signals into an airspace such as signal 210a. A DME equipment included in aircraft 214, for example, can receive signal 210a. It is understood that signal 210a can represent one or several transmissions from radar node 204a, such as a signal transmitted by an airborne DME (at times referred to herein as an interrogator) transmitter during an interrogation phase (e.g., described further with reference to FIG. 2C). In some examples, aircraft 214 can transmit interrogation signal 212a toward radar node 204a. In response to receiving signal 212a, radar node 204a can transition between operating modes and/or transmitting patterns. For example, radar node 204a can transition from an identification mode of operation to an interrogation and/or reply mode of operation. While operating in the identification mode, radar node 204a can transmit a Morse code identifier of an associated location, such as a three-letter identifier of an airport. The transition can include transmitting on one or more frequency channels not used during the identification mode, and/or can include changing a periodicity and/or time-pattern that radar node 204a transmits information. In some examples, a propagation delay is used to determine the distance between the aircraft 214 and the transponder corresponding to radar node 204a. For example, aircraft 214 can transmit interrogation signals to radar node 204a. In response to receiving the interrogation signals, radar node 204a can transmit signals back to aircraft 214, replying to the interrogation from aircraft 214. Aircraft 214 can determine a time between the transmitting of an interrogation signal (e.g., to radar node 204a) and the time of receipt of a signal from radar node 204a (e.g., while radar node 204a is configured in the interrogation and/or reply mode of operation). Based on the time, aircraft can determine the slant range between the radar node 204a and aircraft 214.

In this way, radar node 204a can transmit signals into an airspace, which can help guide aircraft 214 along a transited route. In some examples, as described further herein, transmitted signals intended for a recipient of DME guidance can impinge upon other aircraft in the air space. In some examples, a reflection of the transmitted signals reflecting from the other aircraft can be detected by a receiver, and can be used to identify a presence and/or a location of the other aircraft.

FIG. 2B illustrates an example of a transmitter 204b transmitting signal 210b that reflects off of an aircraft 216 according to examples of the disclosure. The reflection signal 212b can be received by a receiver 202b that is included in a bistatic and/or multi-static radar network. In some examples, transmitter 204b includes one or more characteristics similar to, or the same as described with reference to radar node 204a. For example, transmitter 204b can transmit signal 210b (e.g., a DME signal), which can correspond to an identification signal intended to identify the transmitter 204b to aircraft in an airspace. As described above, the identification signal, in the context of a DME implementation, can inform aircraft that transmitter 204b surrounds a particular landmark and/or geographic area, such as an identifier corresponding to an airport. Additionally or alternatively, transmit signal 210b can correspond to a reply signal (e.g., transmitted by a DME transmitter) intended to communicate with (e.g., provide navigational aid to) an aircraft, such as aircraft 214. As described above, because the radiation pattern of signal 210b can radiate into the air space, signal 210b can impinge upon, and reflect off of an unexpected aircraft (e.g., an aircraft that is not communicating with the DME system and/or is not the intended recipient of a DME transmission) such as aircraft 206. The reflection, corresponding to reflection signal 212b, can radiate through the airspace and can be detected by receiver 202b. In some examples, a processor can cause receiver 202b to communicate the reflected signal 212b and/or information corresponding to the reflected signal 212b to a central processor in communication with receiver 202b.

In some examples, the central processor described above can perform one or more signal processing techniques to determine characteristics of the received signal. Based upon the characteristics of the received signal, the central processor can determine a position, altitude, speed, and/or track of aircraft 206. In some examples, the central processor can cross-reference characteristics of transmitter 204b to determine spatial information about the aircraft 206. For example, the central processor can obtain information such as a coverage volume, power volume, information about an operating status (e.g., offline or online), indications of whether a transmitter such as transmitter 204b may be unreliable, and/or some combination thereof from published sources, such as the FAA. In this way, receiver 202b can be part of a passive radar network that can leverage preexisting transmitters, and can use obtained information cross-referenced with received reflection signals impinging upon an unidentified aircraft to obtain spatial information (e.g., location, speed, altitude, and/or track) of the unidentified aircraft. The aforementioned passive radar network can be used to inexpensively bolster preexisting radar systems and/or independently localize aircraft without requiring management of a transmitter network.

It is understood that FIG. 2B illustrates a simplified scenario, and that additional or alternative possibilities can be contemplated without departing from the scope of the present disclosure. For example, the central processor can cross-reference reflection signals (e.g., different from signal 212b) from additional or alternative receivers, different from receiver 202b, to determine a location of aircraft 206. Additionally or alternatively, the central processor can generate and/or apply a virtual model such as a digital twin to select, sequence, and/or generate a hybridized estimation of spatial information of aircraft.

FIG. 2C illustrates exemplary DME navigational aid transmissions according to examples of the disclosure. In some examples, a DME transmitter 104a and/or 204a can communicate using a channel for an interrogation mode and a channel for a reply mode. For example, during an interrogation mode, a DME transmitter can transmit pulses 228. The pulses can be separated transmitted in pairs, and/or can be separated by an interval 224 in time. When communication with an aircraft relying upon the DME transmitter for navigational aid is established, the DME transmitter can transition to transmitting in a reply mode. While transmitting in the reply mode, the DME transmitter can transmit pulses 230 separated in time by an interval 226.

In some examples, a DME transmitter uses different channels for an interrogation and a reply mode. For example, during the interrogation mode an airborne interrogator transmitter can generate pulses 228 using a first channel (e.g., (“Interrogation Channel X” and “f₁”). Pulses 228 can be repeated at some interval 224 (e.g., 12 μs), which can be defined by a governing body such as the FAA. In some examples, when the radar node detects that an aircraft is in the airspace of the transmitter and ready to send reply signals, the transmitter can transition to the reply mode. Configuring the transmitter in the reply mode can include changing the operating channel of the transmitter to a different channel allocated by the governing body (e.g., “Reply Channel X” and “f₂”). Additionally or alternatively, transmitting while configured in the reply mode can include changing the periodicity and/or interval that signals are transmitted, such as transitioning from interval 224 to interval 226. It can be appreciated, therefore, that bistatic and/or multi-static receivers configured to use DME and/or other transmitters can be highly adaptable.

In some examples, the DME transmissions make use of different channels allocated for the DME system. For example, diagram 240 illustrates a set of transmissions based on a channel (e.g., “Channels Y”) that is related to, but distinct from the transmission illustrated in diagram 220. For example, during the interrogation mode, the DME transmitter or a different transmitter can transmit pulses 238, spaced an interval 234 (e.g., 30 μs) apart in time. When communication with the aircraft relying upon the DME transmitter for navigational aid is established, the DME transmitter can transition to transmitting in the reply mode, indicated by pulses 250 spaced an interval 236 apart in time. In some examples, the DME transmitter relies upon a single interrogation channel (“Interrogation Channel X” and “f₁”) between two channel pairs, but the timing between pulses is different when operating in the reply mode for each channel pair. For example, interval 224 is different from interval 234. Additionally or alternatively, the channels can have different center frequencies. For example, the frequency of “Reply Channel X” is different from the frequency of “Reply Channel Y” (e.g., “f₁” and “f₂” respectively).

In some examples, a central controller can use reflections caused by transmitted signals in one or both of the above-described operating modes. For example, the central controller can use reflected signals caused by interrogation signals, and can forgo use of reflected signals caused by reply signals, or vice-versa. In some examples, receivers can be adaptive and flexible, such that the receivers can be configured to receive signals generated by both interrogation and reply signals. In some examples, one or more of the receivers can detect interrogation channel(s) and/or can detect reply channel(s) in use by transmitters in a geographic region, and can tune to the in-use channels (e.g., alone or collaboratively).

It can be appreciated that implementing a passive radar system when characteristics of a transmitter change may introduce difficulty. For example, changes in power level, frequency channel, and/or transient characteristics of transmission can introduce uncertainty, especially when receiving attenuated reflection signals. Additionally or alternatively, transmitters not controlled and/or configured by a central controller that communicates with the bistatic and/or multi-static passive receivers can vary in transmitting characteristics and/or may be limited in coverage regions in accordance with local geographies. To overcome challenges presented by the uncertainty of a transmitting environment that can be largely uncontrolled by the bistatic and/or multi-static passive radar system, the central controller can perform one or more operations to correlate information about the transmitters available to the central controller with reflected signals received by the passive bistatic and/or multi-static radar system. For example, the central controller can generate, update, and/or utilize a virtual model such as a digital twin of an operating environment of the transmitters. In this way, the radar system can be effectively deterministic—the profile of signals transmitted by DME transmitters are well-defined, thereby improving confidence in localization estimates using reflected signals generated due to the transmitted DME signals.

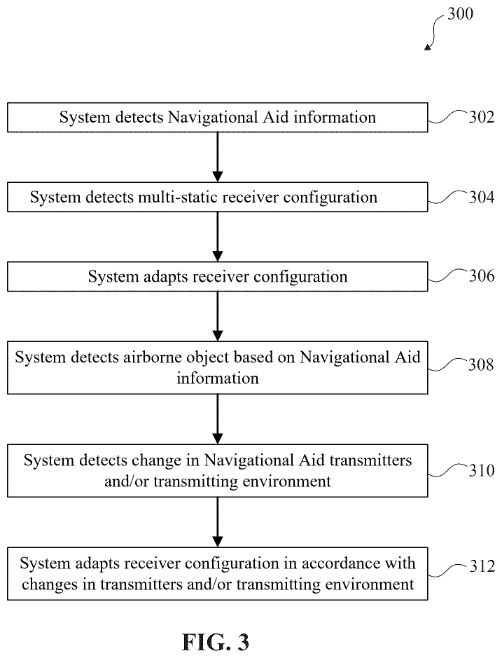

FIG. 3 illustrates a process 300 for detecting airborne objects using adaptative bistatic and/or multi-static radar according to examples of the disclosure. In one or more examples, a radar system such as the bistatic and/or multi-static radar systems described with reference to FIGS. 1 and 2A-2C can configure bistatic and/or multi-static receivers to detect an airborne object. In one or more examples, the configuration of one or more bistatic and/or multi-static receivers can be changed and/or adapted in accordance with DME information (e.g., DME information). For example, a bistatic and/or multi-static receiver can be reconfigured when a transmitter is offline and/or when published characteristics of the transmitter changes.

Process 300 can include operation 302, which includes a system detecting DME information (e.g., the system detects Navigational Aid information). The DME information can include one or more of: location, a type of the DME (e.g., DME, NDB, VOR, and/or ILS), an operating channel and/or typical operating channels, range of a transmitter, the status (e.g., online, offline, or under maintenance), signal and/or modulation type(s), power levels, terrain info, altitudes of unreliability, altitudes of reliability, antenna arrangement(s), and/or some combination thereof. In some examples, the DME information indicates the transmitting characteristics of a transmitter and/or a collection of transmitters. As an example, a DME transmitter located in a mountainous region can be unreliable for a first range of altitudes. The DME information can indicate that the transmitter is unusable or unsuitable for communicating with aircraft under 50 nautical miles, for example. The DME information can further indicate that the transmitter is well suited to communication with aircraft between 50 and 100 nautical miles.

In some examples, process 300 includes operation 304, which includes detecting/determining a multi-static receiver configuration. For example, a central controller can detect (and/or have a priori knowledge of) a spatial distribution and/or location of bistatic and/or multi-static receivers that can be used in a geographic area proximate to a DME transmitter. In some examples, the central controller can detect whether the bistatic and/or multi-static receiver has an appropriate configuration (e.g., number and/or configurability of antennas, sensitivity, directivity, and/or signal processing, and/or operating status) to detect airborne objects in the vicinity of one or more DME transmitters. For example, the central controller can detect that a DME transmitter can transmit signals reliably to aircraft traveling within a first range of altitude and can select one or more receivers for detecting reflections of signals flying within the first range of altitudes based on the characteristic(s) and/or configuration of the receiver.

In some examples, process 300 includes operation 306, which includes adapting the receiver configuration. For example, the central controller can issue a wake-up command to a scanning receiver (e.g., a ground-based scanning receiver), and/or can begin monitoring the signals obtained from a scanning receiver. The scanning receiver can be dedicated for detecting a transmitting channel of a DME transmitter and can be integrated within a receiver used to detect spatial information of unidentified aircraft or can be separate from the receiver (e.g., can be placed near the transmitter). In some examples, the central controller can select and wake-up one or more receivers. In some examples, the central controller can issue a command for one or more receivers to enter a sleep or power saving mode.

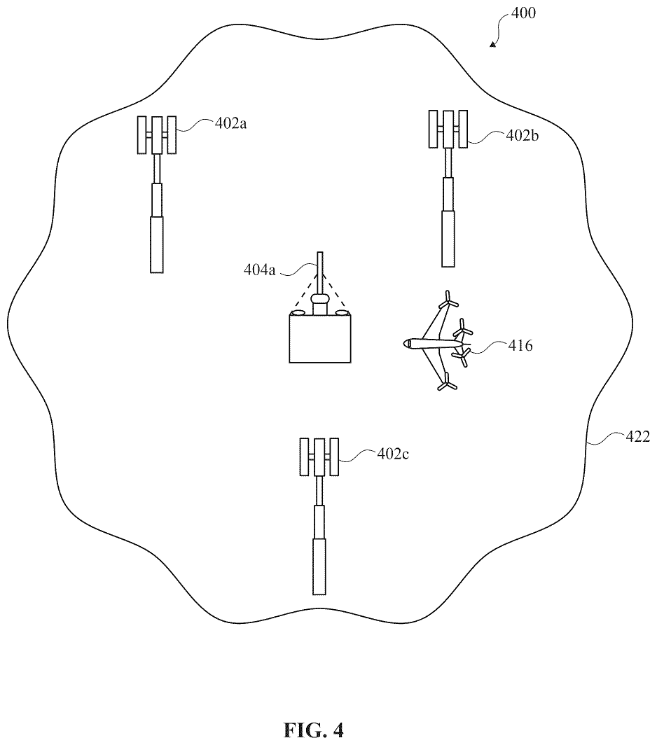

In some examples, process 300 includes operation 308, which includes detecting an airborne object based on the DME information. For example, as described further with reference to FIGS. 2A-2C and 4, the central controller can use a virtual model of an operating environment of the bistatic and/or multi-static radar network to predict the behavior of signals transmitted within the operating environment. In some examples, the virtual model is further used to determine a location and/or other spatial information about an aircraft using signals detected by bistatic and/or multi-static receivers. For example, the bistatic and/or multi-static radar network can detect one or more reflection signals from one or more bistatic and/or multi-static receivers and can cross reference characteristics of the received reflection signals against the virtual model to account for multipath distortion, fading, and/or shadowing. In some examples, the virtual model can incorporate historical information of air traffic through a region. For example, the virtual model can detect information that informs the bistatic and/or multi-static radar network about historical flights of airborne objects relying upon DME through an operating environment of the bistatic and/or multi-static radar network. Knowing that a regularly scheduled flight historically passes through a region including one or more receivers, for example, can bias the model toward accounting for potential DME transmissions that would be guiding such flights, and can apply that knowledge when monitoring the operating environment for other aircraft, such as an aircraft that is not transiting the environment during a time that other flights typically enter the region. Additionally or alternatively, the historical information can suggest that a large amount of activity is historically detected around a time of day. During that time of day, the model can bias toward increasing a weight that reflected signals along a path of historical activity contribute toward localization of an aircraft.

In some examples, process 300 includes operation 310, which includes detecting a change in DME transmitters and/or the transmitting environment. For example, the bistatic and/or multi-static radar system can detect DME information indicating that a status of a DME transmitter has changed from online to offline, or vice-versa. In such an example, the bistatic and/or multi-static radar network can forgo or select a particular DME transmitter as a potential source of signals for radar-based airborne object detection. Additionally or alternatively, the information can indicate a change in the physical environment (e.g., that the transmitter becomes better or ill-suited for certain areas and/or altitude ranges), can indicate a change in the transmitter characteristics (e.g., power level, coverage volume, power volume, range, and/or some combination thereof), and/or can indicate a change in weather patterns that can affect signal propagation. Additionally or alternatively, the information can indicate a maintenance schedule, which can be cross-referenced to ensure that a non-operational transmitter is not assumed to be contributing toward reflection signals received by the bistatic and/or multi-static receiver network. In some examples, process 300 includes operation 312, which includes adapting the receiver configuration in accordance with the change in transmitters and/or transmitting environment (e.g., similarly to, or the same as described with reference to operation 306). It can be appreciated that the operations described with reference to process 300 can be repeated, interchanged, substituted, and/or modified to include the same or similar operations in different sequences.

As described in part above, some examples of the disclosure are directed to generating and using a virtual model such as a digital twin model of a physical environment of the bistatic and/or multi-static radar network. In some examples, the digital twin model can be used to determine placement of receivers within the physical environment. In some examples, based on information gleaned from the digital twin model, the bistatic and/or multi-static radar network can select one or more receivers to determine a location of an airborne object. The one or more receivers, as described with reference to FIG. 3, can detect reflections of DME signals incident upon the airborne object. As described further herein, conventional approaches to airborne object detection cannot enable deterministic radar capabilities without being able to configure and control a source of transmission. By using information published about DME signals and a digital twin model, the passive bistatic and/or multi-static radar networks described with reference to FIG. 4 enable deterministic radar capabilities, thereby enabling precise positioning and/or tracking of aircraft using a passive radar network. As described further above, it is understood that examples described with reference to process 300 can be directed to additional or alternative NAVAIDs that are different from DME NAVAID systems.

As described above, a radar system (such as a multi-static radar system that utilizes reflected DME signals, e.g., a DME radar system) can include receivers that are configured to provide radar coverage in geographic areas around DME transmitters (and/or other NAVAID transmitters). It can be appreciated that while a radar system can successfully detect the location and/or movement of aircraft through the geographic areas without knowledge of the terrain and/or characteristics of the transmitters, knowledge of the terrain and/or the transmitting characteristics of the transmitters can improve the likelihood that the radar system can determine locations of aircraft transiting the geographic areas. In some examples, a central processor of the radar system (as described above) can generate a virtual model of the transmitting environment to determine optimal locations for the receivers of the multi-static radar system and/or configurations of the receivers in view of the terrain and/or transmitting characteristics of the transmitters.

In one or more examples, and optionally independent of detecting an aircraft, the central processor can determine and/or use a virtual model to determine an energy profile of signals that may be transmitted by the transmitters (e.g., the DME transmitters and/or other transmitters of opportunity). The energy profile can determine locations within the geographic areas that improve the likelihood that signals reflecting off of aircraft can be received with a signal power, quality, a SNR, and/or the like that the radar system can use to determine the location and/or movement of the aircraft. Accordingly, the radar system can comprise receivers placed at the locations indicated by the virtual model. Additionally or alternatively, the virtual model can be a dynamic model that is updated as information such as operating status and/or coverage volumes of one or more transmitters change, thereby allowing the radar system to selectively update receiver characteristics and/or enable or disable receivers in accordance with changes to the transmitters.

In one or more examples, the virtual model is determined and maintained using computing resources that are separate from the computing resources used to determine locations and/or movement of aircraft moving through an airspace of the radar system. For example, the energy profile of an environment can be determined before receiving reflection signals at the radar system, thereby reducing processing required to obtain information about the status of transmitters in real-time, and/or processing required to determine the location and/or movement of the aircraft in real-time. In this way, a virtual model can improve the speed and efficiency with which aircraft location and/or movement are determined by the central processor.

As described further below, the virtual model can supplement (or can be determined separately from) operation of a muti-static radar system. In the examples described below, the virtual model is described in the context of the DME radar systems described herein, however, the example should not be seen as limiting, and it is understood that the concepts described below could be applied to other multi-static radar systems that utilize other types of transmitted signals to determine the position of aircraft transmitting an airspace.

FIG. 4 illustrates a multi-static radar network based on a virtual model according to examples of the disclosure. In some examples, a central controller can be used to determine a digital twin model of a physical environment 400. In some examples, the digital twin model can include one or more pieces of information and/or informational sources described with reference to FIGS. 1-3. For example, transmitter 404a can correspond to a DME transmitter. As described above, transmitter 404a can publish and/or a governing body can publish the information describing transmitter 404a. The information can include a power level, a modulation type, a periodicity of transmission, an active/idle pattern of transmissions, an altitude and/or range of altitudes of effective and/or reliable transmissions, range, power spectral density volumes, coverage volumes, operational status, and/or some combination thereof. In this way, the central controller can obtain information about which areas may be conducive to utilizing the transmitter 404a.

In some examples, receivers are placed within physical environment 400 to take advantage of regions 422 where transmitter 404a is effective. It is understood regions 422 is merely one of various examples of the effective transmitting region associated with transmitter 404a, and that regions 422 could have a spatial profile different than expressly illustrated in FIG. 4. For example, receivers 402a-c can be placed around transmitter 404a, avoiding regions where signal degradation due to various modes of interference and/or signal attenuation would render reflected signals unhelpful or unusable. For example, receiver 402c can be placed at an elevation and/or altitude where reflected signals directed toward aircraft 416 traveling at particular altitudes could feasibly be detected by receiver 402c and used to locate aircraft 416. In some examples, knowledge of topography obtained from publicly available sources about physical environment 400 can be incorporated into the digital model in addition to or in the alternative to the information about transmitter 404a.

In some examples, receivers 402a-c can individually or collaboratively contribute toward locating aircraft 416. For example, the central controller can use some or all of the reflected signals received by receivers 402a-c, cross-reference the reflected signals with the digital twin model, and can determine the location of aircraft 416. Thus, the digital twin model can be used to generate an energy profile of the physical environment 400, which can determine whether receivers ought to be placed at particular locations and/or whether reflections received by the receivers can be incorporated into determination of the location of aircraft 416. For example, the central controller can select and/or forgo selection of some or all of receivers 402a-c based on a determination that each receiver can meaningfully contribute toward determining a location of aircraft 416. The digital twin model can be a dynamic model, which can frequently update the determined energy profile in accordance with updated information about transmitters in the physical environment 400, weather patterns, changes in operational status, and/or the like.

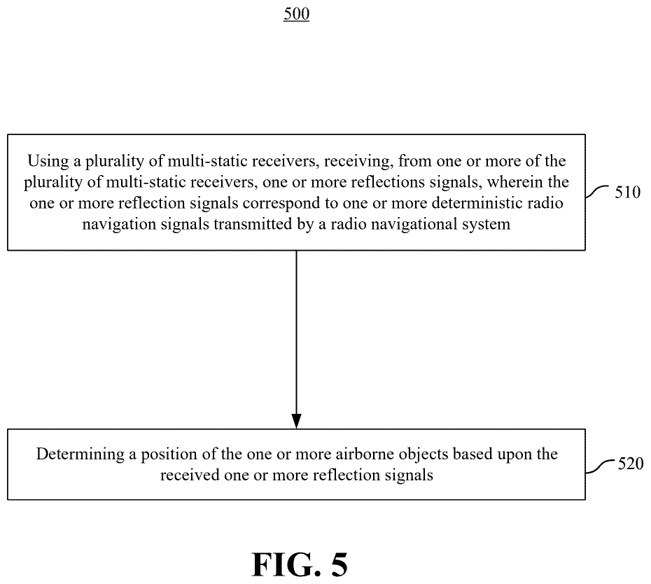

FIG. 5 illustrates an exemplary process for operating a multi-static radar network to detect airborne objects according to examples of the disclosure. In one or more examples, the process 500 of FIG. 5 can be an exemplary process for operating the radar networks described above with respect to FIGS. 1-4. In one or more examples, the process 500 can begin at step 510, and can include one or more processors using one or more receivers to receive one or more reflection signals, wherein the one or more processors can be located at one or more receivers and/or at a central processor and/or system responsible for controlling the one or more receivers. In one or more examples, the one or more reflection signals correspond to one or more deterministic radio navigation signals transmitted by a radio navigational system (e.g., DME signals).

In one or more examples, at step 520, the one or more processors of the system can include determining a position of one or more airborne objects based upon the received one or more reflection signals. As described above, the one or more processors can use a digital model of a physical environment of the radio navigational aid system such that the radio navigational aid systems act as de facto deterministic transmitters for the multi-static radar network (e.g., a DME NAVAID system).

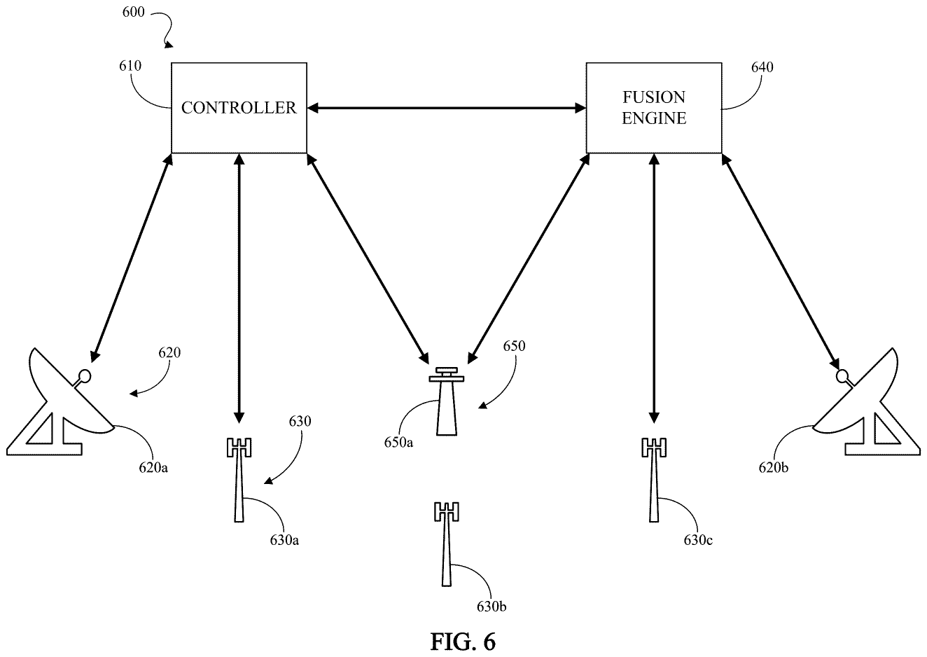

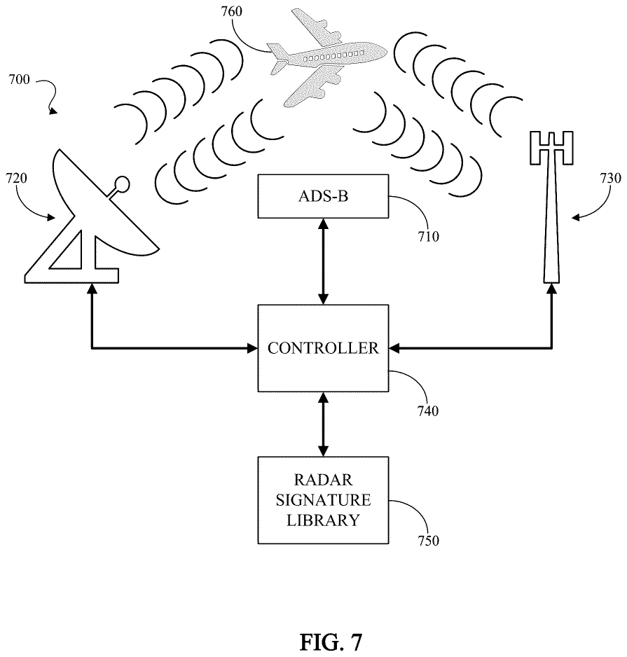

In some examples, a radar fusion engine can correspond to a device or a plurality of devices that combine (i.e., fuse) information from a plurality of radar systems to generate an aggregate understanding of the location and/or movement of an object traversing an airspace. In some examples, the radar fusion engine can be susceptible to ingesting data that is inaccurate and/or associated with a degree of confidence that is lower than an optimal degree of confidence. The aggregated understanding of the location of the object, therefore, can be prone to deficiencies in the health of the radar systems that feed the radar fusion engine. It can be appreciated that there can be a benefit to evaluating the health and/or accuracy of some or all of the plurality of radar systems, and/or that the radar fusion engine can potentially benefit from receiving information indicating that certain radar systems may be the most accurate and/or may be best suited for fusion, while other radar systems may be less accurate and may be unsuitable for fusion. As described in further detail with respect to FIGS. 6 and 7, a device can generate a digital model of a plurality of radar systems in order to generate such recommendations and/or to evaluate the health and accuracy of the plurality of radar systems. In one or more examples, the device can further predict the position and/or track of objects detected by the plurality of radar systems. The device can further communicate feedback to the plurality of radar systems themselves in order to improve performance of the radar systems.

FIG. 6 illustrates an exemplary system for characterizing and recommending radar systems using a virtual model, according to examples of the disclosure. System 600 can include a controller 610 which can be communicatively coupled to a plurality of radar systems, such as radar systems 620, 630 and/or 650. Radar system 620 can include one or more first transmitters and/or receivers such as node 620a and node 620b. Similarly, radar system 630 can include one or more second transmitters and/or receivers such as node 630a, node 630b, and node 630c. In some examples, radar system 620 and/or radar system 630 share one or more characteristics of the radar systems described herein. Radar system 650 can include third one or more transmitters and/or receivers, such as node 650a. System 600 can include and/or be in communication with a radar fusion engine 640. In some examples, radar fusion engine 640 includes one or more devices that are configured to ingest information from controller 610 indicative of the performance of the radar systems 620, 630, and/or 650. In some examples, radar fusion engine 640 can combine the information (e.g., performance, timing, and/or reflection information) to determine the location and/or track of objects moving through an airspace of system 600. For example, the radar fusion engine 640 may be managed by a governing body, such as the Federal Aviation Administration (FAA). As described in greater detail below, controller 610 can evaluate the health and/or accuracy of radar systems 620, 630, and/or 650 and communicate information recommending and/or discouraging the reliance of radar fusion engine 640 on radar systems 620, 630, and/or 650.

In some examples, controller 610 communicates with one or more radio systems and/or networks. For example, radar system 620 can correspond to a plurality of transmitters including parabolic antennas configured for communication. Radar system 630 optionally corresponds to a different type of transmitter and/or radar system network, such as including broadcast transmitters, passive radar networks, deterministic radar networks, conventional radar networks, small-scale high-performance radars, 3G, 4G, long term evolution (LTE), 5G, and/or 6G networks. Additionally or alternatively, radar system 650 optionally includes DME transmitters, similar to or the same as those described with reference to FIG. 2. In some examples, controller 610 may be configured to detect relatively small targets such as Group 1 and/or Group 2 unmanned aerial vehicles that operate below 4000 feet and may communicate with radar systems. In some examples, the unmanned aerial vehicles are configured to detect objects moving under such altitudes and/or with speeds less than larger aircraft such as passenger aircraft and/or freighter aircraft. Additionally or alternatively, controller 610 may optionally be configured to detect and/or facilitate detection of relatively larger targets operating at altitudes above 4000 feet. In some examples, controller 610 may receive information such as automatic dependent surveillance-broadcast (ADS-B) data, which may be indicative of the position and/or track of aircraft transiting an airspace.

As described in greater detail above, controller 610 may be configured to obtain information about one or more of the transmitters included in radar system 620, radar system 630, and/or radar system 650 including the operating status and other specifications about coverage volumes of the one or more transmitters. For example, controller 610 may receive coverage area and/or volume, resolution, bandwidth, impairments due to maintenance downtime and/or adverse weather conditions, and/or additional or alternative information about the one or more transmitters. As informational sources in communication with controller 610 updates such information, controller 610 may update the virtual model to account for the dynamic nature of the systems.

As described above, different transmitters may be configured with different characteristics. For example, a first radar system may include first transmitters operating with first characteristics, and a second radar system may include second transmitters, different from the first transmitters, operating with second characteristics, different from the first characteristics. In this way, controller 610 may be agnostic to the types of transmitters and/or radar system that may be operating and may flexibly analyze an airspace in view of several different types of systems to identify different types of airborne objects and/or the movement and/or position of an aircraft transiting different areas and/or altitudes within the airspace. In some examples, controller 610 may generate the virtual model and/or may be an intermediary for sending information to one or more servers and/or computers to generate the virtual model.

In some examples, controller 610 may generate and/or receive results simulating the performance and/or coverage of the one or more transmitters from the one or more servers and/or computers. In some examples, the results of the virtual model may indicate characteristics of signals reflected off objects traversing an airspace of radar system 620, radar system 630, and/or radar system 650. For example, the results may indicate or be used to determine the speed, location, size, and/or altitude of objects moving through the airspace preemptively (e.g., to predict the movement and/or position of objects). Additionally or alternatively, the virtual model may be used to validate the results of measurements received from one or more receivers included in radar system 620, radar system 630, and/or radar system 650 and/or external to radar system 620, radar system 630, and/or radar system 650, such as one or more receivers in communication with controller 610. In some examples, validating coverage and performance information includes comparing the measurement received from the one or more receivers with the virtual model, as described in greater detail below. In some examples, the virtual model may have one or more characteristics the same as and/or similar to those described with reference to FIGS. 4 and 5, and in further detail above with reference to a digital twin model. It is understood that the examples described with reference to controller 610 are not limited to using navigational aid systems and may ingest other types of transmitting systems to generate a coverage model.

In some examples controller 610 indicates recommendations and/or information corresponding to recommendations to radar fusion engine 640. In some examples, controller 610 may be configured to determine an accuracy and/or level of confidence in the data received from radar systems 620, 630, and/or 650. For example, controller 610 may cross-reference location and/or tracking data received from radar systems 620, 630, and/or 650 such as a velocity, angular location, altitude, cross-sectional area (and/or other information about surface properties of the object), and/or track to determine validation results including a relative accuracy and/or levels of confidence that radar fusion engine 640 may place in the data as compared to results generated by the virtual model. Controller 610 may determine, based on these validation results, that radar system 620 is inaccurate and/or that the confidence level is insufficient based on parameters received from radar fusion engine 640 and may accordingly transmit an indication to radar fusion engine 640 to deprioritize and/or ignore the data received from radar system 620 tracking an object moving through the airspace (e.g., to not recommend radar system 620). Additionally or alternatively, controller 610 may determine that radar system 630 is highly accurate and/or that the confidence level of data received from radar system 630 is greater than a threshold level based on the parameters received from radar fusion 640 (e.g., controller 610 may transmit an indication that radar system 630 is a recommended radar system and/or data source). In this way, controller 610 may generate first validation results and/or second validation results indicative of the performance of the radar systems that are communicating data to controller 610 and/or radar fusion engine 640 based on the virtual model.

In some examples, controller 610 may transmit validation results, including an indication to radar fusion engine 640 to prioritize the data received from radar system 630 tracking the same object moving through the airspace. Conversely, when controller 610 determines that radar system 620 is accurate and/or the confidence level is sufficient and that radar system 630 is not accurate, controller 610 may transmit an indication to use data from radar system 620 and deprioritize and/or ignore data from radar system 630. In this way, controller 610 may provide end users such as air traffic control modules with information about which radar feeds may be used to track objects traversing an airspace in view of the requirements set forth by the end users. Furthermore, controller 610 may indicate which radar system networks may be used as backup informational sources in the event data from a primary radar feed is untrustworthy or is spontaneously non-functional.

In some examples, when the validation results of radar systems 620, 630, and/or 650 satisfy criteria such as a criterion satisfied when the accuracy and/or confidence level are greater than a threshold level of accuracy and/or confidence, controller 610 may indicate that radar systems 620, 630, and/or 650 can be used and/or can be trusted. Radar fusion engine 640 can receive the indication, and/or can receive a prioritization indication from controller 610 indicating which of the two radar systems may be treated as a primary radar source and/or which may be treated as a secondary radar source. In one or more examples, radar fusion engine 640 may, in response to receiving the prioritization indication, initiate locating and/or tracking of the object using radar systems 620, 630, and/or 650, relatively weighing the data received from a respective radar system based on the priority indicated by controller 610 (e.g., weighting data from radar system 620 by amount(s) greater than weights applied to data from radar system 630 when controller 610 indicates radar system 620 may be prioritized, or vice-versa). In this way, radar fusion engine 640 can generate a radar track of objects in an airspace using information received from some or all of radar systems 620, 630, and/or 650.

In some examples, generating a digital model may cause radar systems that are otherwise non-deterministic to be effectively deterministic or pseudo-deterministic sources of information. For example, as described with reference to FIG. 3, the digital model can be based on status information indicating the status of one or more transmitters included in radar systems 620, 630, and/or 650. Thus, based on status information received from radar systems 620, 630, and/or 650 (and/or additional or alternative informational sources exterior to the radar systems), controller 610 may monitor the status of the radar systems 620, 630, and/or 650. Additionally or alternatively, controller 610 may use the information from radar systems 620, 630, and/or 650 to generate a probable next position and/or a predicted track for the object in the airspace. In this way, controller 610 may be precisely aware of the current operating parameters and/or statuses of the one or more transmitters, rather than attempting to infer the status, and consequentially infer the manner by which reflected signals may correlate to transmitted signals. Moreover, the digital model may be updated as operational status of the radar systems 620, 630, and/or 650 change, improving the likelihood that controller 610 prioritizes feeds from respective radar system networks that may be accurate, rather than assuming the respective radar feeds are to be continuously accurate and trusted.

Conventionally, the FAA relies upon automatic dependent surveillance-broadcast (ADS-B) systems to track the position of aircraft moving through an airspace. It may be appreciated that ADS-B data in isolation may be prone to errors and inconsistencies that may erode confidence in the track and/or positional data of an object moving through an airspace such as unexpected delays in data collection and/or reporting. Moreover, the reliance of ADS-B data upon global positioning (e.g., GPS) data enables adversarial entities to spoof the GPS data and/or otherwise interfere with GPS data streams. Drone detection radar (DDR) systems exist, but may lack the resolution, granularity, and/or operational resilience to track objects moving through an airspace with the consistency, accuracy, and flexibility to track changes in operation of transmitters performed the systems described herein. As described in greater detail below, the system proposed herein may effectuate a collaborative and dynamic solution to locate and track objects in the airspace that may facilitate the improvement of performance of radar systems that feed into the system.

In some examples, controller 610 uses and/or facilitates the use of one or more machine learning models to analyze data from radar system feeds, improve the virtual model or an airspace, and/or improve the accuracy of radar systems in communication with controller 610. In some examples, the one or more machine learning models include neural networks, Bayesian networks, convolutional neural networks, and/or deep learning models. Additionally or alternatively, controller 610 may incorporate statistical models and/or calculations that do not strictly require machine learning models to generate a portion or all of the virtual model.

In some examples, controller 610 may be configured to compare modelled results with data received from radar feeds to determine the trustworthiness of the feeds and/or improve the data collected by the corresponding radar networks. For example, controller 610 may detect that radar system 620 is transmitting inaccurate location and/or tracking data by comparing the data received from radar system 620 with modelled data that controller 610 would expect from radar system 620. In some examples, the modelled data is based upon the knowledge of the status of transmitters included in radar system 620 and is based on the data received from other radar systems such as radar system 630. The virtual model, for example, may generate results that indicate that radar system 620 should be generating data indicating that the object is located at a first position, with a first heading, at a first altitude, and/or that there is a first level of confidence (e.g., first level of uncertainty) about the object position, heading, and/or altitude. Radar system 620 may transmit results, which when received by controller 610, may be evaluated as being offset in position, heading, altitude, and/or may be much less or more confident than expected in view of the modelled results. Controller 610 may thereafter determine that radar system 620 is not as accurate as expected and transmit an indicate to radar system 620 to reevaluate the status of the transmitters and/or receivers included in radar system 620. In response to receiving such an indication, radar system 620 may dynamically adjust the operating parameters and/or generate a warning to an operator of radar system 620 to change the operating configuration of transmitters and/or receivers, such as restarting circuitry, changing power levels, changing pulse widths, changing pulse repetition frequency, changing pulse patterns, changing beamforming configurations, changing gain of one or more amplifiers, changing an operating channel, and/or changing a digital filtering of data received via the receivers.

In some examples, controller 610 may indicate the manner by which data from radar systems may be prioritized to determine the position and track of objects moving through an airspace. For example, radar system 620 may correspond to a high frequency radar network which may provide high-resolution, short-range monitoring of an airspace. Additionally, radar system 630 may correspond to DDR network that may cover a relatively larger area than radar system 630, and/or can primarily be configured to monitor the airspace for the approach, departure, and/or flight patterns of aircraft moving through the airspace. Further, controller 610 may receive a radar system feed from a network and/or system that covers a larger area than radar systems 620 and/or 630, such as the transmissions from broadcast towers that surround the airspace. Controller 610 may receive an indication from radar fusion engine 640 that a smaller aircraft may be traversing the airspace, and in response, may transmit an indication that radar system 620 may be prioritized over radar system 630 and/or the broadcast network. Additionally or alternatively, in the event a plurality of friendly objects is traversing the airspace, the controller 610 may monitor the boundaries of the airspace using radar system 630 to detect unexpected objects entering the airspace by transmitting a prioritization of radar system 630. While attempting to track the unexpected objects within the airspace, controller 610 may transmit a prioritization of the radar system 620 to track the position and movement of the unexpected objects in response to detecting the unexpected objects enter the boundaries of the airspace, and radar fusion engine 640 in response to receiving the prioritization may update an ongoing weighting and/or modelling of radar data to prioritize a feed received from radar system 620.

In addition to identifying the position and/or movement of objects in an airspace, it can be appreciated that controller 610 may be configured to generate information that further details characteristics of objects traveling in an airspace. In some examples, controller 610 may be configured to predict a type of aircraft that may correspond to a detected object. As described with greater detail with reference to FIG. 7, controller 610 may be configured to reference a library of radar signatures of other aircraft and may use one or more analytical models to determine whether a currently detected object may correspond to a known type of aircraft. In some examples, the library includes information about radar signatures generated by the different types of transmitters and/or radar networks that are in communication with controller 610.

FIG. 7 illustrates an exemplary system for identifying aircraft based on a collection of radar signatures according to examples of the disclosure. In some examples, controller 740 is the same as or is similar to controller 610. For example, controller 740 may be one example of the common controllers described herein. As described with reference to controller 610, controller 740 may be in communication with one or more transmitters and/or radar networks. For example, radar system 720 and radar system 730 may be similar to, the same as, and/or different from radar system 620, radar system 630, and/or radar system 650. It is understood that any number of networks, any type of suitable communication network, and/or any informational source that may be beneficial in locating and/or tracking airborne objects may be in communication with controller 740. For example, controller 740 may in communication with ADS-B source 710, which may be a device and/or network that is external to or integrated with controller 740. Additionally or alternatively, controller 740 may be in communication with and/or may manage a radar signature library 750.

In some examples, a radar signature is or corresponds to a radar cross-section. In some examples, the radar signature may be a proxy for understanding the detectability of airborne objects. As described in greater detail above, one or more transmitters may transmit waves that are incident upon the airborne objects. In some examples, the waves are at least partially reflected by the airborne objects, and the wave reflections may be detected by one or more receivers, such as receivers in communication with controller 740 or one or more processors or controllers included in radar system 720 and/or 730. It may be appreciated that in practice, the reflections may be detected at receivers, but the signal detected at the receivers may be based upon a complex relationship between object composition, distance, orientation, altitude, and/or frequency of the transmitted and reflected waves, among other factors. In essence, the real-world reflections may vary drastically based upon aircraft geometry, orientation, and the conditions that exist when receivers detect reflections from the aircraft. A radar signature can be determined to ease the modelling of the reflections. In some examples, the radar signature can represent a hypothetical area at which waves from the transmitters could be incident upon, and assuming the waves scatter isotropically, could cause reflections back to the receivers that have a power that is equivalent to the real-world power detected by the receivers. Although the radar signatures can vary based on specific aircraft and other conditions that exist during flight of the aircraft, it can be appreciated that patterns in the signature can be determined by constructing a library of signatures that are mapped to types of known aircraft. By using this library, controller 740 may identify aircraft by comparing live or recent measurements of aircraft signature against the library of radio signatures.

In some examples, controller 740 can receive records of radar signatures of aircraft that are generated by, and/or are generated based upon signals transmitted by networks in cooperation with controller 740. For example, one or more controllers or processors in communication with radar network 720 may transmit radar signatures of aircraft to controller 740. Controller 740 and/or the one or more controllers or processors may update the radar signature library 750 by transmitting information descriptive of the radar signatures, thus updating the radio signature library 750 with radar signature data indicative of a known aircraft. Additionally or alternatively, ADS-B data from ADS-B source 710 may be added to radar signature library and/or may be used by controller 740 to identify the aircraft such that radio signature library 750 includes an identity of the type of aircraft to accompany the relevant radar signature(s). Over time, controller 740 may therefore facilitate population of radar signature library 750 that may be drawn upon at later time(s) for identification of unidentified objects.

In some examples, controller 740 uses information from radar signature library 750 to model previous flights of aircraft. For example, controller 740 may store flight pattern behavior using ADS-B data from ADS-B source 710 to collect live and/or historical data concerning the flight path of aircraft, and/or to collect planned flight paths of the aircraft. In some examples, controller 740 may receive correlate the radar signatures based on measurements from radar systems 720 and/or 730 with the flight path of the aircraft, thereby generating a model for the manner by which the radar signatures change as a function of the changes in position and/or elevation of the aircraft. In some examples, controller 740 stores such radar signatures based on and/or from a plurality of radar networks and may transmit records for the radar signatures to radar signature library 750.

In some examples, controller 740 may generate and/or update one or more statistical, analytical, and/or machine learning models that are used to determine how specific aircraft and/or flight plans influence the determined radar signatures. For example, controller 740 may determine a first radar network provides data about a first type of aircraft (e.g., having first materials and/or having a first spatial profile) given the aircraft is traveling in a certain direction, with a certain speed, at a certain altitude, and/or is a certain range of distances from transmitters and/or receivers included in the first radar network. When the data suggests that a probability of detection (P_{d}) is greater than a threshold probability, controller 740 may determine that the first radar network is well-suited to identifying an aircraft traveling with similar parameters and/or of the same type as suggested by previous measurement. In some examples, based on the suitability of the first radar network for identifying the aircraft, controller 740 may store an indication of the and/or update models used to map between detected aircraft and previous signatures to bias the models toward use of the first radar network when identifying similar aircraft in the future.

In this way, controller 740 may in the future use currently measured radar signature data from the first radar network, compare the currently measured data against historical measurements of radar signatures, determine that the currently detected aircraft bears similarity to the historical measurements of a certain type of aircraft, and may consequentially determine that the detected aircraft matches the previously identified type of aircraft. For example, controller 740 may determine that the aircraft has a radar signature that is similar to or the same as a Cessna® 172 as measured by the first radar network and may determine that the object is a Cessna® 172. Additionally or alternatively, controller 740 may determine the aircraft signature is significantly different from a Boeing® 737 and may accordingly determine that the object is not a Boeing® 737. In some examples, controller 740 transmits an indication of the identified type of aircraft, such as to an entity that includes or corresponds to the radar fusion engine 640 described above. It is understood that any number of analytical frameworks, thresholds, and/or qualitative or quantitative methods may be employed to determine suitability of a given radar system network to detect an aircraft traversing an airspace and/or to map between the library of radar signatures and the aircraft.

In some examples, radar signature library 750 includes information about radar signature of one or more aircraft based on signals transmitted by and/or received at one or more radar networks, as described above. In some examples, radar signature library 750 may be implemented by one or more servers, memory in communication with controller 740, and/or by one or more networks that are external to a device including controller 740. For example, controller 740 may communicate with radar system 720 and/or radar system 730 and additional or alternative receivers external to radar system 720 and/or radar system 730; controller 740, radar system 720, and/or radar system 730 may transmit information to one or more servers which maintain radar signature library 750.

It is understood that the above examples of system 700 which may include controller 740 and/or radar signature library 750 may include additional or alternative circuitry and/or components. For example, system 700 may include radar networks 720 and/or 730. Additionally or alternatively, system 700 may include additional or alternative radar networks. Additionally or alternatively, system 700 may include other informational sources, and/or may include additional or alternative computing circuitry used to generate radar signatures, identify aircraft, run one or more models to identify the aircraft, and/or receive information from and/or transmit information to radar signature library 750.

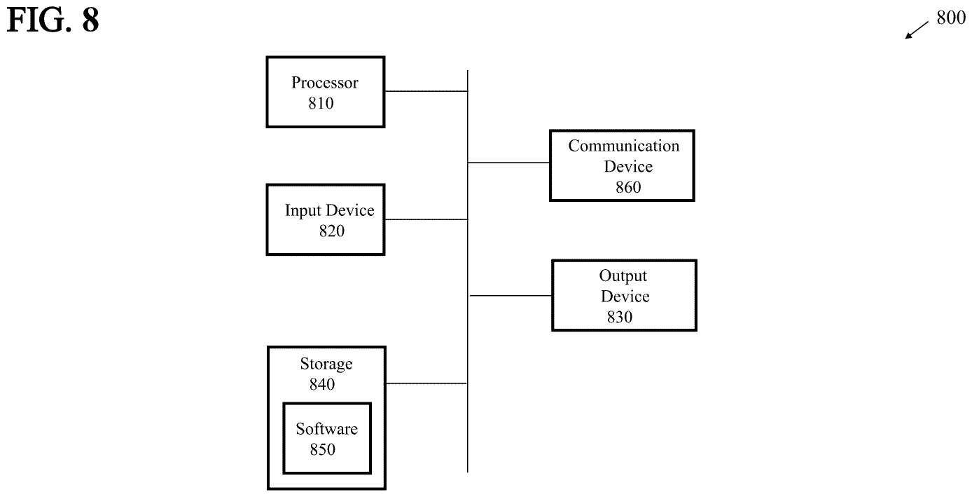

FIG. 8 illustrates an exemplary computing system, according to examples of the disclosure. FIG. 8 illustrates an example of a computing system 800, in accordance with some examples system 800 can be a client or a server. As shown in FIG. 8, system 800 can be any suitable type of processor-based system, such as a personal computer, workstation, server, handheld computing device (portable electronic device) such as a phone or tablet, or dedicated device. The system 800 can include, for example, one or more of input device 820, output device 830, one or more processors 810, storage 840, and communication device 860. Input device 820 and output device 830 can generally correspond to those described above and can either be connectable or integrated with the computer.

Input device 820 can be any suitable device that provides input, such as a touch screen, keyboard or keypad, mouse, gesture recognition component of a virtual/augmented reality system, or voice-recognition device. Output device 830 can be or include any suitable device that provides output, such as a display, touch screen, haptics device, virtual/augmented reality display, or speaker.

Storage 840 can be any suitable device that provides storage, such as an electrical, magnetic, or optical memory including a RAM, cache, hard drive, solid state drive (SSD), removable storage disk, or other non-transitory computer readable medium. Communication device 860 can include any suitable device capable of transmitting and receiving signals over a network, such as a network interface chip or device. The components of the computing system 800 can be connected in any suitable manner, such as via a physical bus or wirelessly.

Processor(s) 810 can be any suitable processor or combination of processors, including any of, or any combination of, a central processing unit (CPU), field programmable gate array (FPGA), and application-specific integrated circuit (ASIC). Software 850, which can be stored in storage 840 and executed by one or more processors 810, can include, for example, the programming that embodies the functionality or portions of the functionality of the present disclosure (e.g., as embodied in the devices as described above).

Software 850 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium. In some instances, such a transport computer readable medium may include or correspond to a non-transitory computer readable storage medium.

System 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 800 can implement any operating system suitable for operating on the network. Software 850 can be written in any suitable programming language, such as C, C++, Java, or Python. In various examples, application software embodying the functionality of the present disclosure can be deployed in different configurations, such as in a client/server arrangement or through a Web browser as a Web-based application or Web service, for example.

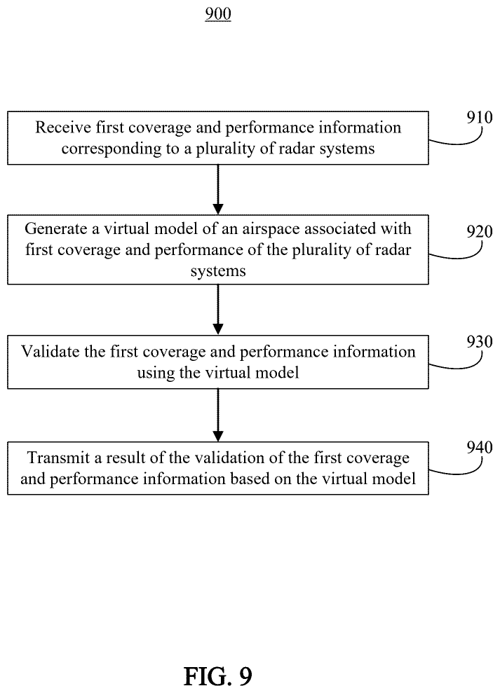

FIG. 9 illustrates an exemplary process for operating a multi-static radar network to detect airborne objects according to examples of the disclosure. In one or more examples, the process 900 of FIG. 9 can be an exemplary process for operating the radar networks described above with respect to FIGS. 1-4, and/or 6-7. In one or more examples, the process 900 can begin at step 910, and can include one or more processors using receiving first coverage and performance information corresponding to a plurality of radar systems. In one or more examples, the process 900 can include generating, at step 920, a virtual model of an airspace associated with first coverage and performance of the plurality of radar systems. In one or more examples, the process 900 can include validating, at step 930, the first coverage and performance information using the virtual model. In one or more examples, the process 900 can include, at step 940, transmitting a result of the validation of the first coverage and performance information based on the virtual model.

The foregoing description, for the purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated. For the purpose of clarity and a concise description, features are described herein as part of the same or separate examples; however, it will be appreciated that the scope of the disclosure includes examples having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. An electronic device comprising:
a memory;
one or more processors;
wherein the memory stores one or more programs that when executed by the one or more processors, cause the one or more processors to:
receive first coverage and performance information corresponding to a plurality of radar systems;
generate a virtual model of an airspace associated with first coverage and performance of the plurality of radar systems;
validate the first coverage and performance information using the virtual model; and
transmit a result of the validation of the first coverage and performance information based on the virtual model.

2. The electronic device of claim 1, wherein:
the result of the validation is communicated to a second electronic device that is different from the electronic device, and
the second electronic device is configured to generate a radar track based on information received from the plurality of radar systems, and the one or more programs when executed further cause the one or more processors to:
transmit, to the second electronic device, one or more recommended radar systems selected from the plurality of radar systems based on the result of the validation.

3. The electronic device of claim 1, wherein the one or more programs when executed further cause the one or more processors to apply one or more machine learning models to the received first coverage and performance information to combine information received from the plurality of radar systems.

4. The electronic device of claim 1, wherein the result of the validation indicates performance of one or more radar systems included in the plurality of radar systems.

5. The electronic device of claim 1, wherein the first coverage and performance information include automatic dependent surveillance-broadcast (ADS-B) data received from one or more flights transiting a coverage area of the plurality of radar systems.

6. The electronic device of claim 1, wherein the one or more programs when executed further cause the one or more processors to:
receive radar signature information from one or more of the radar systems of the plurality of radar systems, wherein the radar signature information includes a plurality of radar signatures corresponding to a plurality of aircraft; and
identify an aircraft moving through an airspace of the one or more radar systems, wherein the identification of the aircraft is based on a comparison between a measured radar signature received from the one or more radar systems and the plurality of radar signatures previously received from the one or more radar systems.

7. The electronic device of claim 1, wherein the one or more programs when executed further cause the one or more processors to:
receive an indication of changes to one or more radar systems included in the plurality of radar systems; and
in response to receiving the indication of the changes, update the virtual model based on the changes to the one or more radar systems.

8. A method for detecting and tracking one or more airborne objects:
receiving first coverage and performance information corresponding to a plurality of radar systems;
generating a virtual model of an airspace associated with first coverage and performance of the plurality of radar systems;
validating the first coverage and performance information using the virtual model; and
transmitting a result of the validation of the first coverage and performance information based on the virtual model.

9. The method of claim 8, wherein:
the result of the validation is communicated to an electronic that is configured to generate a radar track based on information received from the plurality of radar systems, the method further comprising:
transmitting one or more recommended radar systems selected from the plurality of radar systems based on the result of the validation.

10. The method of claim 8, further comprising applying one or more machine learning models to the received first coverage and performance information to combine information received from the plurality of radar systems.

11. The method of claim 8, wherein the first coverage and performance information include automatic dependent surveillance-broadcast (ADS-B) data received from one or more flights transiting a coverage area of the plurality of radar systems.

12. The method of claim 8, further comprising:
receiving radar signature information from one or more of the radar systems of the plurality of radar systems, wherein the radar signature information includes a plurality of radar signatures corresponding to a plurality of aircraft; and
identifying an aircraft moving through an airspace of the one or more radar systems, wherein the identification of the aircraft is based on a comparison between a measured radar signature received from the one or more radar systems and the plurality of radar signatures previously received from the one or more radar systems.

13. The method of claim 8, further comprising:
receiving an indication of changes to one or more radar systems included in the plurality of radar systems; and
in response to receiving the indication of the changes, updating the virtual model based on the changes to the one or more radar systems.

14. A non-transitory computer readable storage medium storing one or more programs for detecting and tracking one or more airborne objects, for execution by one or more processors of an electronic device that when executed by the electronic device, cause the electronic device to:
receive first coverage and performance information corresponding to a plurality of radar systems;
generate a virtual model of an airspace associated with first coverage and performance of the plurality of radar systems;
validate the first coverage and performance information using the virtual model; and
transmit a result of the validation of the first coverage and performance information based on the virtual model.

15. The non-transitory computer readable storage medium of claim 14, wherein:
the result of the validation is communicated to a second electronic device that is different from the electronic device, and
the second electronic device is configured to generate a radar track based on information received from the plurality of radar systems, and the one or more programs when executed further cause the one or more processors to:
transmit, to the second electronic device, one or more recommended radar systems selected from the plurality of radar systems based on the result of the validation.

16. The non-transitory computer readable storage medium of claim 14, wherein the one or more programs when executed further cause the electronic device to apply one or more machine learning models to the received first coverage and performance information to combine information received from the plurality of radar systems.

17. The non-transitory computer readable storage medium of claim 14, wherein the first coverage and performance information include automatic dependent surveillance-broadcast (ADS-B) data received from one or more flights transiting a coverage area of the plurality of radar systems.

18. The non-transitory computer readable storage medium of claim 14, wherein the one or more programs when executed further cause the electronic device to:
receive radar signature information from one or more of the radar systems of the plurality of radar systems, wherein the radar signature information includes a plurality of radar signatures corresponding to a plurality of aircraft; and
identify an aircraft moving through an airspace of the one or more radar systems, wherein the identification of the aircraft is based on a comparison between a measured radar signature received from the one or more radar systems and the plurality of radar signatures previously received from the one or more radar systems.

19. The non-transitory computer readable storage medium of claim 14, wherein the one or more programs when executed further cause the electronic device to:
receive an indication of changes to one or more radar systems included in the plurality of radar systems; and
in response to receiving the indication of the changes, update the virtual model based on the changes to the one or more radar systems.

20. The-transitory computer readable storage medium of claim 14, wherein the result of the validation indicates performance of one or more radar systems included in the plurality of radar systems.
